(19) United States
(12) Patent Application Publication
(10) Pub. No.: US 2021/0026037 A1
(43) Pub. Date: Jan. 28, 2021

(54) Wellbore Survey Tool Using Coriolis Vibratory Gyroscopic Sensors

(71) Applicant: Gyrodata, Incorporated, Houston, TX (US)

(72) Inventors: John Lionel Weston, Christchurch (GB); Adrián Guillermo Ledroz, Houston, TX (US); Onyemelem Yegbefume, Spring, TX (US)

(21) Appl. No.: 17/070,844

(22) Filed: Oct. 14, 2020

Related U.S. Application Data
(63) Continuation-in-part of application No. 16/437,947, filed on Jun. 11, 2019.
(60) Provisional application No. 62/914,957, filed on Oct. 14, 2019.
(60) Provisional application No. 62/758,674, filed on Nov. 11, 2018.
(60) Provisional application No. 62/750,128, filed on Oct. 24, 2018.

(51) Int. Cl. G01V 11/00; G01C 21/16; E21B 7/04; E21B 47/022; E21B 47/024

(52) U.S. Cl. CPC G01V 11/002; G01C 21/16; E21B 47/024; E21B 47/022; E21B 7/04

(57) ABSTRACT

Various implementations described herein may refer to a wellbore survey tool using Coriolis vibratory gyroscopic sensors. In one implementation, a method may include receiving one or more reference values corresponding to the Earth's rotation rate and one or more reference values corresponding to a local latitude of a survey tool disposed in a wellbore. The method may also include receiving rotation rate measurements from one or more quartz Coriolis vibratory gyroscopic (CVG) sensors of the survey tool. The method may further include determining bias-corrected rotation rate measurements using one or more statistical estimation processes and based on the one or more reference values corresponding to the Earth's rotation rate, the one or more reference values corresponding to the local latitude, and the rotation rate measurements. The method may additionally include determining azimuth values of the survey tool based on the bias-corrected rotation rate measurements.

### CROSS-REFERENCE TO RELATED APPLICATIONS

This application claims the benefit of and priority to U.S. Provisional Patent Application No. 62/914,957, filed Oct. 14, 2019 and titled NON-INDEXING GYROSCOPIC SURVEY TOOL, and is a continuation-in-part of U.S. patent application Ser. No. 16/437,947, filed Jun. 11, 2019 and titled WELLBORE SURVEY TOOL USING CORIOLIS VIBRATORY GYROSCOPIC SENSORS, which claims the benefit of and priority to U.S. Provisional Patent Application Ser. Nos. 62/758,674, filed Nov. 11, 2018 and 62/750,128, filed Oct. 24, 2018, both titled WELLBORE SURVEY TOOL BASED ON CORIOLIS VIBRATORY GYROSCOPIC SENSORS, and each of the aforementioned are herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

A survey tool may be used in a directional survey of a wellbore, where the survey tool may include one or more gyroscopic sensors configured to provide at least one data signal indicative of the orientation of the survey tool relative to the rotation axis of the Earth. In particular, the one or more gyroscopic sensors may be configured to measure one or more components of the Earth's rotation rate. These measurements may then be used in combination with measurements of tool inclination and tool face angle to compute an azimuth of the survey tool and, hence, an azimuth of the wellbore at the location of the survey tool within the wellbore. Various types of gyroscopic sensors may be used for such directional surveys.

### SUMMARY

Described herein are implementations of various technologies relating to a wellbore survey tool using Coriolis vibratory gyroscopic sensors. In one implementation, a method may include receiving one or more reference values corresponding to the Earth's rotation rate and one or more reference values corresponding to a local latitude of a survey tool disposed in a wellbore. The method may also include receiving a plurality of rotation rate measurements from one or more quartz Coriolis vibratory gyroscopic (CVG) sensors of the survey tool. The method may further include determining a plurality of bias-corrected rotation rate measurements using one or more statistical estimation processes and based on the one or more reference values corresponding to the Earth's rotation rate, the one or more reference values corresponding to the local latitude, and the plurality of rotation rate measurements. The method may additionally include determining a plurality of azimuth values of the survey tool based on the plurality of bias-corrected rotation rate measurements.

In another implementation, a system may include a survey tool disposed in a wellbore, where the survey tool includes one or more quartz Coriolis vibratory gyroscopic (CVG) sensors. The system may also include a processor and a memory having a plurality of program instructions which, when executed by the processor, cause the processor to receive one or more reference values corresponding to the Earth's rotation rate and one or more reference values corresponding to a local latitude of a survey tool disposed in a wellbore. The plurality of program instructions which, when executed by the processor, may also cause the processor to receive a plurality of rotation rate measurements from the one or more quartz CVG sensors of the survey tool. The plurality of program instructions which, when executed by the processor, may further cause the processor to determine a plurality of bias-corrected rotation rate measurements using one or more statistical estimation processes and based on the one or more reference values corresponding to the Earth's rotation rate, the one or more reference values corresponding to the local latitude, and the plurality of rotation rate measurements. The plurality of program instructions which, when executed by the processor, may additionally cause the processor to determine a plurality of azimuth values of the survey tool based on the plurality of bias-corrected rotation rate measurements.

In yet another implementation, a method may include receiving one or more reference values corresponding to the Earth's rotation rate and one or more reference values corresponding to a local latitude of a survey tool disposed in a wellbore. The method may also include receiving a plurality of rotation rate measurements from one or more quartz Coriolis vibratory gyroscopic (CVG) sensors about an x-axis, a y-axis, and a z-axis of the survey tool, wherein the z-axis corresponds to a longitudinal axis of the survey tool, and wherein the x-axis and y-axis are substantially perpendicular to the z-axis. The method may further include determining a plurality of bias-corrected rotation rate measurements using one or more statistical estimation processes and based on the one or more reference values corresponding to the Earth's rotation rate, the one or more reference values corresponding to the local latitude, and the plurality of rotation rate measurements. The method may additionally include determining a plurality of azimuth values of the survey tool based on the plurality of bias-corrected rotation rate measurements. The method may also include generating a survey of the wellbore based on the plurality of azimuth values. The method may further include drilling the wellbore based on the generated survey.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a survey operation in accordance with implementations of various techniques described herein.

FIG. 2 illustrates a cross-sectional side view of a survey tool in accordance with implementations of various techniques described herein.

FIG. 3 illustrates a schematic diagram of the chassis unit in accordance with implementations of various techniques described herein.

FIG. 4 illustrates a schematic diagram of the chassis unit in accordance with implementations of various techniques described herein.

FIG. 5 illustrates a cross-sectional bottom view of the survey tool in accordance with implementations of various techniques described herein.

FIG. 6 illustrates a flow diagram of a method for correction of rotation rate measurements in accordance with implementations of various techniques described herein.

FIG. 7 illustrates a flow diagram of a method for correction of rotation rate measurements in accordance with implementations of various techniques described herein.

FIG. 8 illustrates a schematic diagram of a computing system in which the various technologies described herein may be incorporated and practiced.

### DETAILED DESCRIPTION

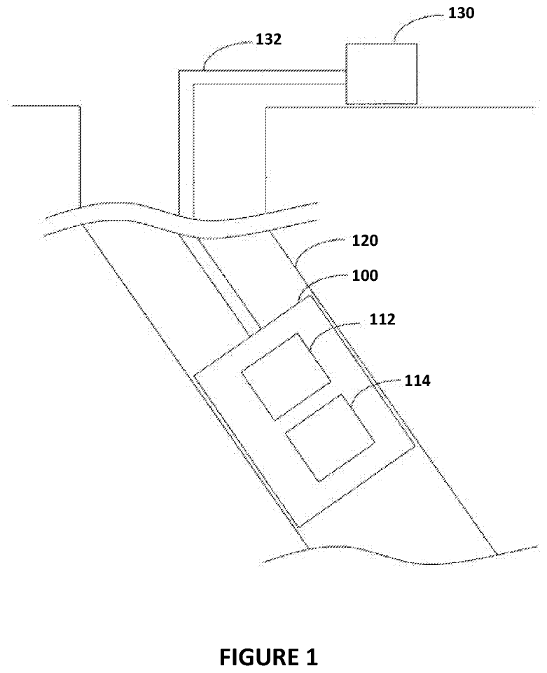

Various implementations directed to a wellbore survey tool using Coriolis vibratory gyroscopic sensors will now be described in the following paragraphs with reference to FIGS. 1-8.

To obtain hydrocarbons such as oil and gas, directional wells may be drilled through Earth formations along a selected trajectory. The selected trajectory may deviate from a vertical direction relative to the Earth at one or more inclination angles and at one or more azimuth directions with respect to north along the length of the wellbore. As such, measurements of the inclination and azimuth of the wellbore may be obtained during drilling to determine whether the selected trajectory is being maintained.

As is known in the art, a directional survey may be performed to measure the inclination and azimuth at selected positions (e.g., one or more survey stations) along the wellbore using a survey tool. Such a directional survey may include a gyrocompassing survey (i.e., a static survey in which measurements of the Earth's rate are taken at discrete intervals on the wellbore trajectory) and/or a continuous survey (i.e., a survey in which measurements of the tool change in orientation are taken as the survey tool traverses the wellbore). In particular, the survey tool can be used to perform a directional survey and/or other collection of measurements in conjunction with various applications, including surveys conducted during the drilling of a wellbore (e.g., measurement-while-drilling (MWD) or gyro-while-drilling (GWD) applications), post-drilling applications (e.g., wireline surveys, slickline surveys, or drop surveys), and/or any other applications known to those skilled in the art.

Further, the survey tool may include sensors configured to generate measurements corresponding to the instrument orientation with respect to one or more reference directions, to the Earth's magnetic field, and/or to the Earth's gravity, where the measurements may be used to determine azimuth and inclination along the wellbore. For example, the survey tool may include one or more accelerometers configured to measure one or more orthogonal components of the Earth's gravity, where the measurements may be used to generate an inclination angle and a toolface angle of the survey tool.

The survey tool may also include one or more gyroscopic sensors configured to measure one or more components of the Earth's rotation rate about one or more orthogonal axes of the survey tool. These measurements from the gyroscopic sensors may then be used in combination with measurements of tool inclination and tool face angle to compute an azimuth of the survey tool, and, hence, an azimuth of the wellbore at the location of the survey tool within the wellbore. In particular, the gyroscopic sensors may be configured to generate signals indicative of measurements of the rotation rate to which the gyroscopic sensors are exposed.

The gyroscopic sensors may include a spinning mass gyroscopic sensor, such as a single-axis rate integrating gyroscopic sensor or a dual-axis dynamically tuned gyroscopic sensor; an optical gyroscopic sensor, such as a ring laser gyroscopic sensor (RLG) or a fiber-optic gyroscopic sensor (FOG); a microelectromechanical system (MEMS) gyroscopic sensor; and/or any other implementation known to those skilled in the art. Some gyroscopic sensors, such as the spinning mass gyroscopic sensor, may be subject to a variety of error sources, such as gravity dependent errors resulting from mass unbalance changes and other imperfections within the sensor.

In one implementation, the gyroscopic sensors used in the survey tool may include a type of solid state sensor referred to as a Coriolis vibratory gyroscopic (CVG) sensor. CVG sensors may include a tuning fork gyroscopic sensor, a hemispherical resonator gyroscopic sensor (HRG), and/or any other form of CVG sensors known in the art. As is known in the art, CVG sensors may use a vibrating element to determine a rate of rotation. In particular, a basic principle of operation of such sensors is that the vibratory motion of the vibrating element may create an oscillatory linear velocity. If the sensor is in the presence of a rotational field, a Coriolis acceleration may be induced. This acceleration may modify the nature of the vibrating element, and this change can be detected and used to determine the magnitude of the applied rotation.

In another implementation, CVG sensors may incorporate either a silicon or a quartz resonator with piezo-electric driver circuits. Further, these sensors may use piezo-electric or capacitive pick-offs to detect the motion of the vibrating element due to Coriolis forces. In yet another implementation, relatively small variations of these sensors, which may be MEMS gyroscopic sensors, may be fabricated using chemical etching and batch processing techniques known to those skilled in the art. In addition, CVG sensors used in a survey tool may have a bias stability of hundredths of a degree/hour, which may be suitable for wellbore survey applications.

In some implementations, CVG sensors may be more suitable for use in a survey tool when compared to other types of gyroscopic sensors, such as conventional mechanical gyroscopic sensors (e.g., conventional spinning mass gyroscopic sensors). In particular, when compared to other gyroscopic sensors, CVG sensors may have a relatively rugged construction and may be able to withstand applied accelerations of many tens of thousands of g-forces. Further, CVG sensors may be less susceptible to g-dependent effects, and thus may lessen the effect that g-dependent errors may have on survey accuracy, particularly when compared to conventional mechanical gyroscopic sensors. Further, with respect to wellbore surveying and construction, the application of CVG sensors may lead to: a reduction in the physical size of survey tools incorporating these sensors; a reduction in power requirements; reduced survey time, as spinning mass gyroscopes take time for the rotor to reach the required spin speed; and increased time intervals between recalibrations of the survey tool.

In various implementations further described below, a survey tool using one or more CVG sensors may be used to perform a directional survey to measure an inclination and azimuth at selected positions along a wellbore. In particular, the one or more CVG sensors may be used to measure one or more components of the Earth's rotation rate about one or more orthogonal axes of the survey tool. Further, the one or more CVG sensors may include one or more quartz CVG sensors. Such quartz CVG sensors may include quartz tuning fork gyroscopic sensors and/or the like. The use of quartz CVG sensors may allow for operation of the survey tool at relatively high temperatures (e.g., up to 160° Celsius (C)) that may be encountered underground.

### Survey Tool

FIG. 1 illustrates a schematic diagram of a survey operation in accordance with implementations of various techniques described herein. As shown, the survey operation may be performed using a survey tool 100 and a computing system 130.

The survey tool 100 may be disposed within a wellbore 120, and may be used in conjunction with various applications, as discussed below. The survey tool 100 may be part of a downhole portion (e.g., a bottom hole assembly) of a drill string (not pictured) within the wellbore 120. In particular, the survey tool 100 may be a GWD survey tool, where it may be part of a GWD drill string used to drill the wellbore 120. In conventional systems, the GWD survey tool 100 may be used to acquire measurements (i.e., survey data) while the drill string is drilling the wellbore 120 and being extended downwardly along the wellbore 120. While the survey tool 100 is discussed below in terms of a GWD survey tool, those in the art will understand that the survey tool 100 may also be in the form of a wireline survey tool, a slickline survey tool, a drop survey tool, a survey tool used in logging or drilling applications, a survey tool used in measurement-while-drilling applications, and/or any other survey tool known to those skilled in the art.

To acquire the survey data, the survey tool 100 may use one or more gyroscopic sensors 112, one or more accelerometers 114, one or more magnetic sensors, one or more gamma ray sensors, and/or any other sensors known to those skilled in the art. The one or more gyroscopic sensors 112 may include one or more quartz CVG sensors, as described above. The one or more gyroscopic sensors 112 may also include any other gyroscopic sensor known in the art, such as those discussed above. The one or more gyroscopic sensors 112 may be capable of providing measurements of the Earth's rotation rate to the desired accuracy (e.g., in a range from 0.01°/hour to 0.05°/hour). The one or more gyroscopic sensors 112 may be sufficiently small to be accommodated in a downhole tool (e.g., within the confines of a 1¾-inch pressure case of a wellbore), capable of operating over an expected temperature range (e.g., −20° Celsius (C) to +150° C., or greater), and/or capable of surviving the down hole vibration and shock environment that may be encountered during the drilling process.

Further, the gyroscopic sensors 112 may include one or more dual-axis gyroscopic sensors, one or more single-axis gyroscopic sensors, or combinations thereof that are configured to provide measurements of the Earth's rotation rate about various axes of the survey tool. In particular, a dual-axis gyroscopic sensor and/or one or more single-axis gyroscopic sensors may be used to provide measurements of the Earth's rotation rate about two axes (i.e., x-axis and y-axis) of the survey tool, where the two axes are substantially perpendicular to a longitudinal axis (i.e., z-axis) of the survey tool and are substantially perpendicular to one another. In another implementation, the z-axis of the survey tool 100 may be parallel to the longitudinal axis of the wellbore 120.

For example, a dual-axis gyroscopic sensor (which hereinafter may be referred to as a xy-gyroscopic sensor) may be configured to provide both measurements of a component of the Earth's rotation rate with respect to the x-axis of the survey tool and measurements of a component of the Earth's rotation rate with respect to the y-axis of the survey tool. In another example, one single-axis gyroscopic sensor may be used to provide measurements of the Earth's rotation rate about the x-axis (which hereinafter may be referred to as a x-axis gyroscopic sensor), and another single-axis gyroscopic sensor may be used to provide measurements of the Earth's rotation rate about the y-axis (which hereinafter may be referred to as a y-axis gyroscopic sensor).

In addition, the gyroscopic sensors 112 may include a z-axis gyroscopic sensor, which may be used to provide measurements of the Earth's rotation rate about the z-axis of the survey tool. The z-axis gyroscopic sensor may be a single-axis gyroscopic sensor or a dual-axis gyroscopic sensor, as is known to those skilled in the art.

The one or more accelerometers 114 may be configured to measure one or more orthogonal and/or non-orthogonal components of the Earth's gravity, where these measurements may be used to generate an inclination angle and a toolface angle of the survey tool 100, as is known to those skilled in the art. In particular, the one or more acceleration sensors 114 may include one or more dual-axis or one or more single-axis accelerometers configured to provide measurements of the orthogonal components (gₓ, g_{y}, g_{z}) of the Earth's gravitation vector with respect to the x, y, and z-axes of the survey tool 100.

Various types of accelerometers may be used, such as quartz flexure accelerometers, MEMS accelerometer devices, and/or any other type of accelerometers known to those skilled in the art. In one implementation, the measurement range of the accelerometers may be in excess of ±1 unit of standard gravity (g) (e.g., in a range between ±1.2 g and ±1.5 g). Further, the accelerometers may be of a size that can be accommodated in a downhole tool (e.g., within the confines of a 1¾ inch pressure case of a wellbore), capable of operating over an expected temperature range (e.g., −20° C. to +150° C., or greater), and capable of surviving the downhole vibration and shock environment that may be encountered during the drilling process. The resolution and precision of the one or more accelerometer sensors can depend on the time and the desired angular rate uncertainty. For example, for errors below a maximum error on a toolface rate of 0.05°/hour over 15 seconds, the at least one accelerometer can provide noise levels below 0.14 mg. An analog-to-digital system with a range of ±1.2 g and 16 bits can give a resolution of 0.036 mg/count, which can satisfy the desired noise levels. If the time is increased, the accelerometer uncertainty can be increased as well.

In one implementation, the computing system 130 may be used to process the data acquired by the survey tool 100. In some implementations, the computing system 130 may be coupled to the survey tool 100 so as to provide control signals to the survey tool 100 to control an orientation of the one or more gyroscopic sensors 112, as further described below. The computing system 130 may be configured to receive and/or transmit data with respect to the tool 100 using any form of communication known to those skilled in the art. In one such implementation, the computing system 130 may be disposed at the surface and may be communicatively coupled to the survey tool 100 by an elongate portion 132 (e.g., a wire or cable) such that the measurements may be transmitted between the survey tool 100 and the computing system 130 located at the surface. In some implementations, an entirety of or at least a portion of the computing system 130 may be located in the survey tool 100 within the wellbore 120. The computing system 130 can be any computing system implementation known to those skilled in the art. Various implementations of the computing system 130 are further discussed in a later section.

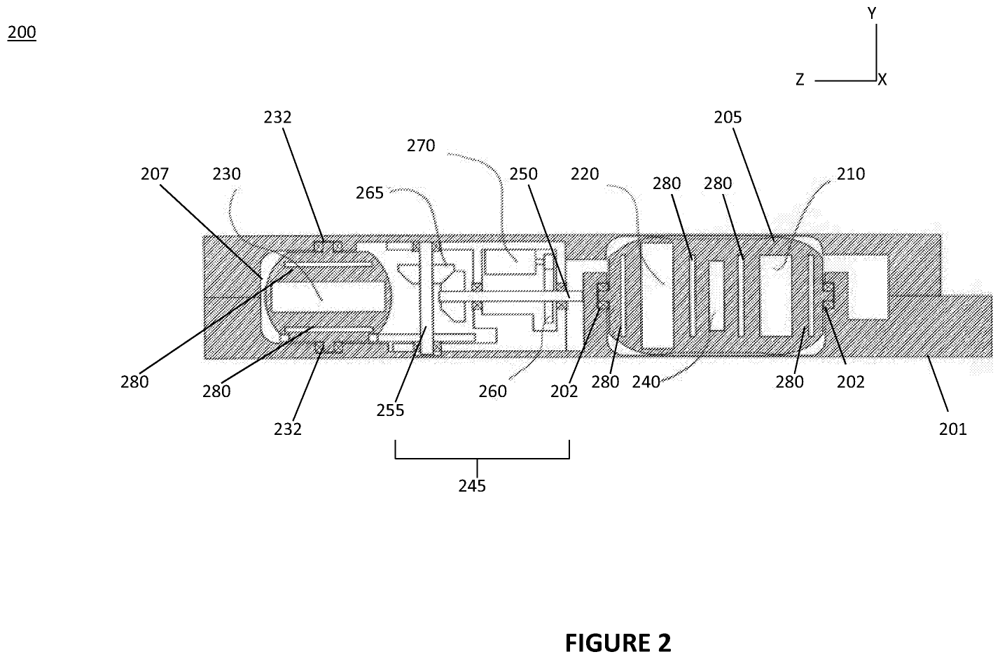

Further implementations of a survey tool using one or more CVG sensors are discussed below. FIG. 2 illustrates a cross-sectional side view of a survey tool 200 in accordance with implementations of various techniques described herein. As shown, the survey tool 200 may be similar to the survey tool 100 discussed above. In particular, similar to the tool 100, the survey tool 200 may be a GWD survey tool configured to be positioned in a downhole portion (e.g., a bottom hole assembly) of a drill string (not pictured) within the wellbore, where the tool 200 includes one or more quartz CVG sensors and one or more accelerometers.

As shown, the x-axis, y-axis, and z-axis of the survey tool 200 may be orthogonal to one another, where the z-axis may correspond to the longitudinal axis of the tool 200. The survey tool 200 may include three single-axis quartz CVG sensors 210, 220, and 230. In particular, the survey tool 200 includes an x-axis CVG sensor 210, a y-axis CVG sensor 220, and a z-axis CVG sensor 230. The survey tool 200 also includes a dual-axis accelerometer 240 configured to provide measurements of the orthogonal components (gₓ, g_{y}) of the Earth's gravitation vector with respect to the x and y-axes of the survey tool 200. The survey tool 200 may also include another accelerometer (not pictured) to provide measurements of the orthogonal component (g_{z}) of the Earth's gravitation vector with respect to the z-axis of the survey tool 200.

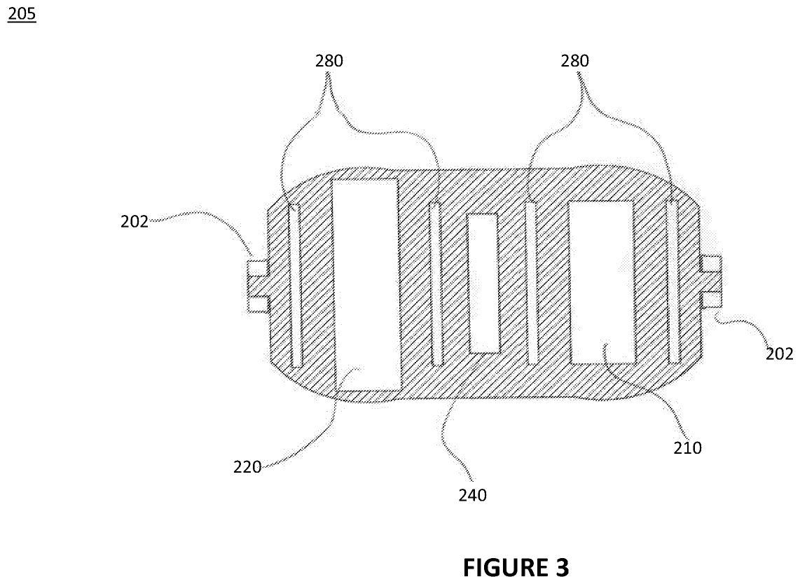

In addition, the CVG sensors 210, 220 and the accelerometer 240 may be housed together in a chassis unit 205, along with two circuit boards 280 mounted on each side of each sensor 210, 220. The circuit boards 280 may represent vibration drive circuitry and/or Coriolis motion detection circuitry associated with the sensors 210, 220. FIG. 3 illustrates a schematic diagram of the chassis unit 205 in accordance with implementations of various techniques described herein. The chassis unit 205 may be configured to rotate about the z-axis of the tool 200, such that the CVG sensors 210, 220 and the accelerometer 240 may be configured to rotate about the z-axis of the tool 200 as the unit 205 rotates. In one implementation, the chassis unit 205 may include bearings 202 at each end, where the bearings 202 may be used to support the unit 205 and to facilitate the rotation of the unit 205 about the z-axis. The rotation of the CVG sensors 210, 220 may be used for indexed bias removal, as further discussed in a later section. Any bearings 202 known in the art may be used.

Referring back to FIG. 2, the chassis unit 205 may be rotated about the z-axis using a motor unit 245. The motor unit 245 may include a motor 270, a first shaft 250, a second shaft 255, one or more spur gears 260, and one or more miter gears 265. As shown in FIG. 2, the motor 270 is configured to use the spur gears 260 to transmit a rotation force to the first shaft 250, where a rotation of the first shaft 250 leads to a rotation of the chassis unit 205 (and, in turn, the CVG sensors 210, 220).

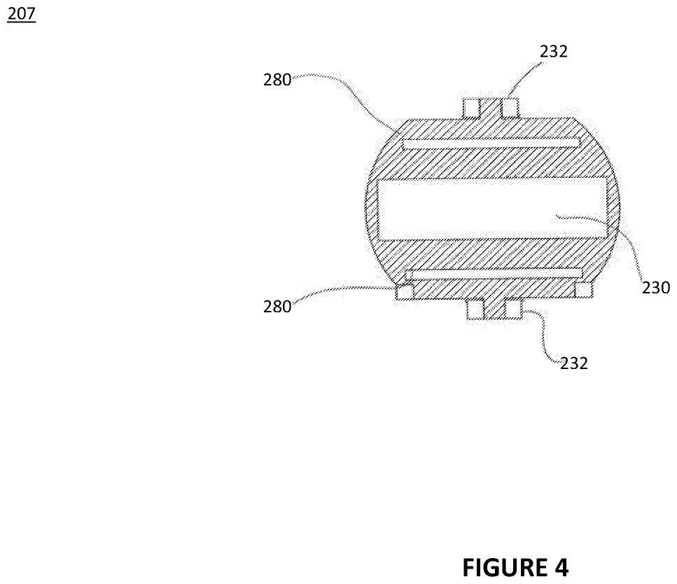

As is also shown, the z-axis CVG sensor 230 may be housed in a chassis unit 207, along with two circuit boards 280 mounted on each side of the sensor 230. The circuit boards 280 may represent vibration drive circuitry and/or Coriolis motion detection circuitry associated with the sensor 230. As shown, the chassis unit 207 may be disposed on the other side of the tool 200 from the chassis unit 205, such that the motor unit 245 separates the two units 205, 207. FIG. 4 illustrates a schematic diagram of the chassis unit 207 in accordance with implementations of various techniques described herein. The chassis unit 207 may be configured to rotate about the y-axis of the tool 200, such that the CVG sensor 230 may be configured to rotate about the y-axis of the tool 200 as the unit 207 rotates. In one implementation, the chassis unit 207 may include bearings 232 at each end, where the bearings 232 may be used to support the unit 207 and to facilitate the rotation of the unit 207 about the y-axis. The rotation of the CVG sensor 230 may be used for indexed bias removal, as further discussed in a later section. Any bearings 232 known in the art may be used.

The chassis unit 207 may also be rotated about the y-axis using the motor unit 245. In particular, as the motor 270 operates to rotate the first shaft 250, a miter gear 265 coupled to the first shaft engages with a miter gear 265 coupled to the second shaft 255, such that rotation of the first shaft 250 may lead to a rotation of the second shaft 255. In turn, the rotation of the second shaft 255 may cause the chassis unit 207 to rotate about the y-axis, thereby leading to a rotation of the CVG sensor 230 about the y-axis. As such, the motor unit 245 may be used to rotate the CVG sensors 210, 220, and 230 in cooperation with each other. Any implementation for the motor unit 245 known to those skilled in the art may be used, as well.

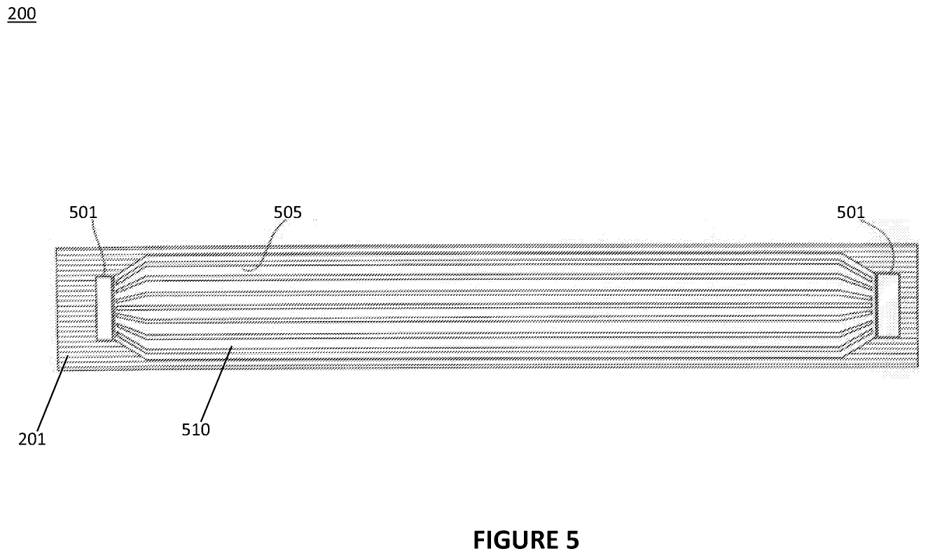

FIG. 5 illustrates a cross-sectional bottom view of the survey tool 200 in accordance with implementations of various techniques described herein. In particular, FIG. 5 illustrates a cross-sectional view of the bottom side 201 of the tool 200. As shown, one or more cabling connections 510 may be disposed along the bottom side 201 of the tool 200, such that the connections 510 may positioned away from the chassis units 205, 207 and the motor unit 245. As also shown, the cabling connections 510 may be coupled to electrical connectors 501 at each end of the tool 200, thereby allowing for electrical communication (i.e., signal, power, and/or the like) at each end of the tool 200. Such a configuration may enable both signal and power communication to other items in the drill string assembly above and below the survey tool 200, thus allowing the tool 200 to be placed anywhere in the drill string. In addition, this configuration may allow the tool 200 to be run “upside-down” or connected to additional tools of the same type. The tool 200 may also include a temperature sensor for every CVG sensor for the purpose of calibration and temperature compensation.

### Indexing

As mentioned above, a survey tool may include one or more quartz CVG sensors configured to measure one or more components of the Earth's rotation rate about one or more orthogonal axes of the survey tool. These measurements from the CVG sensors may then be used in combination with measurements of tool inclination and tool face angle to compute an azimuth of the survey tool, and, hence, an azimuth of the wellbore at the location of the survey tool within the wellbore. In particular, the CVG sensors may be configured to generate signals indicative of measurements of the rotation rate to which the CVG sensors are exposed.

However, in some instances, the measurements provided by a CVG sensor of a survey tool may contain fixed, systematic errors or biases that may severely impact the accuracy of the sensor's measurements and, thus, the azimuth. In particular, the measurements provided by a CVG sensor may be in error owing to a variety of causes, such as measurement biases, mounting misalignments of the CVG sensor, scale factor errors, and/or other imperfections known to those skilled in the art. These causes may give rise to errors in the measurements provided by the CVG sensor.

In some scenarios, measurement biases may be the dominant cause of errors in the measurements provided by a CVG sensor. As such, in one implementation, to compensate for the bias values in the measurements from a CVG sensor, an indexing procedure may be performed on the sensor. As is known to those skilled in the art, a CVG sensor may be indexed by adjusting the sensor to two or more positions and using measurements from the two or more positions to determine the bias values.

In one such implementation, indexing of an x-axis, y-axis, or xy-gyroscopic sensor may performed by using the sensor to measure the Earth's rotational rate at two different index positions that are 180 degrees apart from one another. In particular, the sensor of the sensor may be rotated about the z-axis of the survey tool to turn the sensor between the two index positions. In some implementations, the sensor may be mounted on a rotatable platform that can be turned to various index positions.

For example, a single-axis gyroscopic sensor may provide measurements of the Earth's rotation rate about the x-axis of the survey tool, and may be configured to rotate about the z-axis of the survey tool between a first index position and a second index position. The first index position and the second index position may be 180 degrees apart, and the sensor may provide a measurement at each index position. Because the index positions are 180 degrees apart, one measurement may be a positive value while the other measurement may be a negative value, whereas any bias values may maintain the same sign. As such, by summing the two measurements and dividing by two, an estimate of the bias value may be obtained. This bias value may then be used to correct subsequent measurements from the sensor prior to determining the azimuth of the survey tool. In addition, by calculating the difference between the two measurements and dividing by two, a more accurate measurement of the Earth's rotation rate about the x-axis can be obtained with the effect of any bias largely removed. This more accurate measurement may hereinafter be referred to as a bias corrected measurement or a bias corrected rotation rate measurement.

As is known to those skilled in the art, a similar indexing procedure may be performed on a single-axis CVG sensor that provides measurements of the Earth's rotation rate about the x, y, or z-axis of the survey tool alone. Further, as is also known to those skilled in the art, a similar indexing procedure may be performed on a dual-axis CVG sensor configured to provide measurements of the Earth's rotation rate with respect to the x-axis, the y-axis, and/or z-axis of the survey tool, where measurements may be taken with respect to the x-axis, the y-axis, and/or the z-axis at each index position. As such, the indexing procedure may be used to determine a bias value for each of the x-axis, the y-axis, and/or the z-axis, and may be used to determine a bias corrected measurement of the Earth's rotation rate about each of the x-axis, the y-axis, and/or the z-axis. In addition, indexing of a sensor may be performed by using the sensor to measure the Earth's rotational rate at more than two different index positions, such as four index positions separated by 90 degrees (i.e., the difference between the first index position and the second index position can be 90 degrees, the difference between the second index position and the third index position may be 90 degrees, and the difference between the third index position and the fourth index position may be 90 degrees). Other orientations and number of index positions may be used, as well. Further implementations of indexing procedures are further described in commonly-assigned U.S. Pat. No. 8,374,793, the entire disclosure of which is herein incorporated by reference.

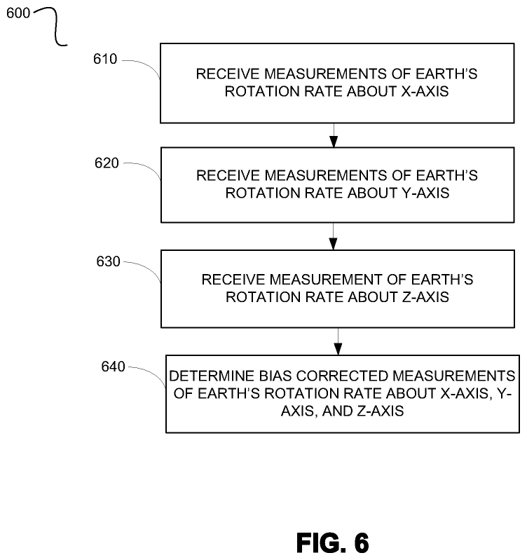

FIG. 6 illustrates a flow diagram of a method 600 for correction of rotation rate measurements in accordance with implementations of various techniques described herein. In one implementation, method 600 may be at least partially performed by a computing system, such as the computing system 130 discussed above. It should be understood that while method 600 indicates a particular order of execution of operations, in some implementations, certain portions of the operations might be executed in a different order. Further, in some implementations, additional operations or steps may be added to the method 600. Likewise, some operations or steps may be omitted.

As noted above, the computing system 130 may be used to provide control signals to a survey tool to control an orientation of the one or more gyroscopic sensors, such as by operating a motor unit 245 for a survey tool 200. In addition, the computing system 130 may be configured to receive measurements of the Earth's rotation rate from the one or more CVG sensors of the tool, and to calculate information regarding one or more bias values in the measurements.

At block 610, the computing system may receive one or more measurements of the Earth's rotation rate about the x-axis of a survey tool from one or more quartz CVG sensors of the tool. As noted above, the one or more CVG sensors may include a dual-axis CVG sensor, one or more single-axis CVG sensors, or combinations thereof.

In one implementation, the computing system may receive at least two measurements of the Earth's rotation rate about the x-axis that were taken at two or more index positions. As noted above, in one example, the index positions may include a first index position and a second index position that are 180 degrees apart, where an x-axis CVG sensor rotates about the z-axis of the survey tool to turn the x-axis CVG sensor between the two index positions. In another example, the index positions may include a first index position, a second index position, a third index position, and a fourth index position that are 90 degrees apart, where an x-axis CVG sensor rotates about the z-axis of the survey tool to turn the x-axis CVG sensor between the four index positions. As also noted above, a different number of index positions may be used, as well. In one such implementation, the computing system may be used to rotate the x-axis CVG sensor about the z-axis by operating a motor unit of the sensor.

At block 620, the computing system may receive one or more measurements of the Earth's rotation rate about the y-axis of a survey tool from the one or more CVG sensors. As noted above, the x-axis and the y-axis may be substantially perpendicular to a longitudinal axis (i.e., z-axis) of the survey tool and may be substantially perpendicular to one another. In one implementation, one dual-axis CVG sensor may be used to provide measurements of the Earth's rotation rate about both the x-axis and the y-axis of the survey tool.

In another implementation, the computing system may receive at least two measurements of the Earth's rotation rate about the y-axis that were taken at two or more index positions. As noted above, in one example, the index positions may include a first index position and a second index position that are 180 degrees apart, where a y-axis CVG sensor rotates about the z-axis of the survey tool to turn the y-axis CVG sensor between the two index positions. In another example, the index positions may include a first index position, a second index position, a third index position, and a fourth index position that are 90 degrees apart, where a y-axis CVG sensor rotates about the z-axis of the survey tool to turn the y-axis CVG sensor between the four index positions. As also noted above, a different number of index positions may be used, as well. In one such implementation, the computing system may be used to rotate the y-axis CVG sensor about the z-axis by operating a motor unit of the sensor.

At block 630, the computing system may receive one or more measurements of the Earth's rotation rate about the z-axis of a survey tool from the one or more CVG sensors of the tool. As noted above, the one or more CVG sensors may include a dual-axis CVG sensor, one or more single-axis CVG sensors, or combinations thereof.

In one implementation, the computing system may receive at least two measurements of the Earth's rotation rate about the z-axis that were taken at two or more index positions. As noted above, in one example, the index positions may include a first index position and a second index position that are 180 degrees apart, where a z-axis CVG sensor rotates about the x-axis or y-axis of the survey tool to turn the z-axis CVG sensor between the two index positions. In another example, the index positions may include a first index position, a second index position, a third index position, and a fourth index position that are 90 degrees apart, where a z-axis CVG sensor rotates about the x-axis or y-axis of the survey tool to turn the z-axis CVG sensor between the four index positions. As also noted above, a different number of index positions may be used, as well. In one such implementation, the computing system may be used to rotate the z-axis CVG sensor about the x-axis or y-axis by operating a motor unit of the sensor.

At block 640, the computing system may determine a bias corrected measurement of the Earth's rotation rate about the x-axis of the survey tool, may determine a bias corrected measurement of the Earth's rotation rate about the y-axis of the survey tool, and may determine a bias corrected measurement of the Earth's rotation rate about the z-axis of the survey tool.

As noted above, a bias corrected measurement may be determined by calculating a difference between measurements of the Earth's rotation rate taken from two index positions and dividing by two. The bias corrected measurement may be a more accurate measurement of the Earth's rotation rate, as it may eliminate bias value. For example, using three single-axis CVG sensors to provide measurements of the Earth's rotation rate about the x-axis, the y-axis, and the z-axis of the survey tool at a first index position and a second index position, the measurements of the Earth's rotation rate about the x-axis (ωₓ₀), the y-axis (ω_{y0}), and the z-axis (ω_{z0}) that were taken at the first index position may be:

ωₓ₀=ωₓ+Bₓ, (1)

ω_{y0}=ω_{y}+B_{y}, (2)

ω_{z0}=ω_{z}+B_{z}, (3)

where ωₓ represents a bias corrected measurement of the Earth's rotation rate about the x-axis of the survey tool, ω_{y} represents a bias corrected measurement of the Earth's rotation rate about the y-axis of the survey tool, ω_{z} represents a bias corrected measurement of the Earth's rotation rate about the z-axis of the survey tool, Bₓ represents a bias value in the measurements of the Earth's rotation rate about the x-axis, B_{y} represents a bias value in the measurements of the Earth's rotation rate about the y-axis, and B_{z} represents a bias value in the measurements of the Earth's rotation rate about the z-axis.

Further, using the three single-axis CVG sensors to provide measurements of the Earth's rotation rate about the x-axis, the y-axis, and the z-axis of the survey tool, the measurements of the Earth's rotation rate about the x-axis (ωₓ₁), the y-axis (ω_{y1}), and the z-axis (ω_{z1}) that were taken at a second index position disposed 180 degrees from the first position may be:

ωₓ₁=−ωₓ+Bₓ; (4)

ω_{y1}=−ω_{y}+B_{y}; (5)

ω_{z1}=−ω_{z}+B_{z}. (6)

The bias values may be obtained by summing the respective measurements and dividing by two:

Bₓ=(ωₓ₀+ωₓ₁)/2; (7)

B_{y}=(ω_{y0}+ω_{y1})/2; (8)

B_{z}=(ω_{z0}+ω_{z1})/2. (9)

The bias corrected measurement about each axis may be determined by calculating the difference between the respective measurements and dividing by two:

ωₓ=(ωₓ₀−ωₓ₁)/2; (10)

ω_{y}=(ω_{y0}−ω_{y1})/2; (11)

ω_{z}=(ω_{z0}−ω_{z1})/2. (12)

A similar procedure may be performed to determine the bias corrected measurements for implementations using more than two index positions. In a further implementation, the bias corrected measurements of the Earth's rotation rate about the x-axis, the y-axis, and the z-axis of the survey tool may also be used to determine an azimuth of the survey tool and, hence, an azimuth of the wellbore. Such implementations may be used to mitigate the impact of bias values on the accuracy of the CVG sensor's measurements and, thus, the azimuth.

In such an implementation, the azimuth of the wellbore may be determined using the following equations:

$$\begin{matrix}α = arctan [ \frac{- {g}_{x}}{- {g}_{y}} ] & ( 13 ) \\ I = arctan [ \frac{\sqrt{{g}_{x}^{2} + {g}_{y}^{2}}}{{g}_{z}} ] & ( 14 ) \\ {ω}_{x} = Ω ( cos φ cos A cos I + sin φ sin I ) sin α + Ω cos φ sin A cos α & ( 15 ) \\ {ω}_{y} = Ω ( cos φ cos A cos I + sin φ sin I ) cos α - Ω cos φ sin A sin α & ( 16 ) \\ {ω}_{z} = Ωcos φ cos A sin I - Ω sin φ cos I & ( 17 ) \\ A = arctan [ \frac{{ω}_{x} cos α - {ω}_{y} sin α}{( {ω}_{x} sin α + {ω}_{y} cos α ) cos I + {ω}_{z} sin I} ] & ( 18 )\end{matrix}$$

where a represents toolface angle, I represents the inclination angle, gₓ, g_{y}, and g_{z} represent orthogonal components of the Earth's gravitation vector, Ω represents the Earth's rotation rate, A represents azimuth, ωₓ represents the bias corrected measurement of the Earth's rotation rate about the x-axis of the survey tool, ω_{y} represents the bias corrected measurement of the Earth's rotation rate about the y-axis of the survey tool, and ω_{z} represents the bias corrected measurement of the Earth's rotation rate about the z-axis of the survey tool.

Implementations relating to a wellbore survey tool using CVG sensors are disclosed herein. In particular, the survey tool may include quartz CVG sensors to perform a directional survey to measure an inclination and azimuth at selected positions along a wellbore. In particular, the one or more CVG sensors may be used to measure one or more components of the Earth's rotation rate about one or more orthogonal axes of the survey tool.

In some implementations, CVG sensors may be more suitable for use in a survey tool when compared to other types of gyroscopic sensors, such as conventional mechanical gyroscopic sensors (e.g., conventional spinning mass gyroscopic sensors). In particular, when compared to other gyroscopic sensors, CVG sensors may have a relatively rugged construction and may be able to withstand applied accelerations of many tens of thousands of g-forces. Further, CVG sensors may be less susceptible to g-dependent effects, and thus may lessen the effect that g-dependent errors may have on survey accuracy, particularly when compared to conventional mechanical gyroscopic sensors. Further, with respect to wellbore surveying and construction, the application of CVG sensors may lead to: a reduction in the physical size of survey tools incorporating these sensors; a reduction in power requirements; reduced survey time, as spinning mass gyroscopes take time for the rotor to reach the required spin speed; and increased time intervals between recalibrations of the survey tool. In addition, one or more implementations for the survey tool disclosed herein may be able to measure the Earth's rotation and gravity fields in approximately thirty seconds, may not require additional time for rig operations, may not require regular calibrations for its sensors, may avoid mass unbalance errors, may operate in all latitudes, may operate in all attitudes, may automatically collect surveys while the tool is stationary, may have a relatively short tool length with the sensors proximate to the drill bit, may reduce error ellipses, may reduce costs, and may be accurate in high shock, high vibration, and high temperature environments.

Further, using the implementations described above, the bias values may be used to correct rotation rate measurements from a survey tool, which may then be used to more accurately determine an azimuth of the survey tool, and, hence, an azimuth of the wellbore at the location of the survey tool within the wellbore. This azimuth of the wellbore may then be used to determine the extent to which the wellbore deviates from a particular trajectory. One or more drilling operations may be used based on this determined deviation, including a change in the steering of drilling equipment within the wellbore.

Further, one or more implementations described herein may utilize wellbore gyroscopic survey tools that allow for gyrocompassing/north finding to be performed irrespective of the attitude or orientation of the survey tool, and may be able to perform this function both rapidly and accurately. In addition, one or more implementations disclosed herein may advantageously index the x-axis, y-axis and z-axis CVG sensors and accelerometers. For example, such implementations may allow for a rapid gyrocompassing alignment of the survey tool to be carried out when the tool is horizontal, thereby avoiding the singularity problem that arises when using a xy-gyroscopic sensor system only. Furthermore, various methods are known in the art for indexing CVG sensors for the purpose of identifying and removing systematic biases in the measurements provided by each sensor.

Additionally, one or more implementations described herein may provide a number of options in terms of the relative orientation of the sensitive axes of the CVG sensors, the choice of index rotation angles that may be used, and the application of different gyro technologies. These different options may arise as result of performance considerations and spatial limitations which determine how a particular survey tool may be mounted within a narrow tube, as may be required for downhole applications and underground surveying generally.

Further, implementations for the survey tool described herein can be used to estimate the orientation of the tool while steering or sliding. This process may be designed to keep track of the tool face, or reference, while drilling and in order to follow the well path. Because of the dynamic conditions and high rate of rotations, the system used for gyrocompassing may not be well suited for this. One option may be to electronically adjust the range of the z-axis output of the CVG sensor for this purpose. For example, the range can be set as 0 to 100 degrees/hour for gyrocompassing and 0 to 500 degrees/second for steering operations.

### Statistical Estimation Process

As mentioned above, a survey tool (such as those discussed with respect to FIGS. 1-6) may include one or more quartz CVG sensors configured to measure one or more components of the Earth's rotation rate about one or more orthogonal axes of the survey tool. In particular, these measurements from the CVG sensors may be acquired at selected positions (e.g., one or more survey stations) along a wellbore, such as through a gyrocompassing survey (i.e., a stationary survey in which measurements of the Earth's rotation rate are taken at the selected positions on the wellbore trajectory). Further, these measurements may then be used in combination with measurements of tool inclination and tool face angle to compute an azimuth of the survey tool, and, thus, an azimuth of the wellbore at the location of the survey tool within the wellbore. In particular, the CVG sensors may be configured to generate signals indicative of measurements of the rotation rate to which the CVG sensors are exposed.

However, as noted above, the measurements provided by a CVG sensor of a survey tool may contain systematic errors or biases that may severely impact the accuracy of the sensor's measurements and, thus, the azimuth. In particular, the measurements provided by a CVG sensor may be in error owing to a variety of causes, such as measurement bias errors (or changes), mounting misalignments of the CVG sensor, scale factor errors, and/or other imperfections known to those skilled in the art. These causes may give rise to errors in the measurements provided by the CVG sensor. For example, variations may arise in the magnitude of error terms for the CVG sensors between a calibration of a survey tool and its subsequent operational use in the field.

As such, in one implementation, to remove or reduce measurement biases in the measurements from a CVG sensor, one or more statistical estimation processes may be used. In such an implementation, a statistical estimation process for the calculation of the measurement bias contributions may be constructed based on a mathematical model of the system that yields estimates of the gyroscopic measurement errors.

In particular, the statistical estimation process may be used to estimate a residual measurement bias associated with each CVG sensor at each survey station. These measurement biases may be used to derive bias-corrected rotation rate measurements, which, in turn, may be used to determine a more accurate azimuth of the survey tool at each survey station. In some implementations, the one or more statistical estimation processes may be used to estimate the measurement biases based on a rotation rate of the Earth and/or a local latitude of the survey tool.

The one or more statistical estimation processes may be applied to rotation rate measurements acquired using any survey tool known in the art, including the survey tools with CVG sensors that are discussed above with respect to FIGS. 1-6. Further, the one or more statistical estimation processes may be implemented using any computing system known in the art, such as the computing systems discussed above with respect to FIGS. 1-6. As noted above, the computing system may be disposed at the surface, may be entirely or at least partially located in the survey tool within the wellbore, or combinations thereof. The computing system may implement the one or more statistical estimation processes while the survey tool is in operation (e.g., while drilling), post-drilling, and/or the like. In one implementation, the computing system may be used to determine a measurement bias associated with each CVG sensor of the survey tool at each survey station, determine bias-corrected rotation rate measurements based on the measurement biases, and then determine an azimuth of the survey tool at each survey station based on the corrected measurements.

### Kalman Filter Process

In one implementation, the statistical estimation process used to estimate a residual measurement bias associated with each CVG sensor of a survey tool may be in the form of a Kalman filter process. The Kalman filter process may be applied to rotation rate measurements acquired using any survey tool known in the art, including survey tools configured to perform MWD or GWD applications. In one implementation, the Kalman filter process may allow for the estimates of measurement bias to be updated at each survey station and may, therefore, be implemented in real time during the well drilling process.

In some implementations, a computing system may estimate measurement biases using the Kalman filter process based on the Earth's rotation rate and the local latitude of the survey tool. The Earth's rotation rate and the local latitude may be known quantities, as their values may be obtained from sources that are separate and/or independent from the survey tool. In particular, these quantities may be derived using systems separate from the gyroscopic sensors or the accelerometers of the survey tool. The Earth's rate and the local latitude can be used as pseudo-measurements in the Kalman filtering process, and may be expressed in vector form as:

z=[Ωϕ]^{T} (19)

where Ω represents the Earth's rotation rate and ϕ represents the local latitude.

For example, the mean rotation rate of the Earth is 7.292115×10⁻⁵ radians/second (or 15.041067 degrees/hour), and this rotation rate information can be obtained from various sources, including, but not limited to, the International Earth Rotation and Reference Systems Service (IERS) and the World Geodetic System WGS-84 model. In addition, local latitude information can be obtained from various sources, including, but not limited to, a satellite navigation system (e.g., a global positioning system).

At least some, or all, of this rotation rate information and local latitude information, or at least a portion of signals indicative of this rotation rate information and local latitude information, can be stored. In particular, the information may be stored in a memory and/or storage device accessible to the computer system mentioned above, where the system may include a processor configured to perform the calculations described herein. For example, a value or other information of the Earth's rotation rate can be stored using memory (e.g., dynamic random access memory device or other tangible computer-readable memory) that is part of a system separate from the one or more gyroscopic sensors within the portion of the wellbore. In another example, a value or other information of the local latitude information can be stored using memory (e.g., dynamic random access memory device or other tangible computer-readable memory) that is part of a system separate from the one or more gyroscopic sensors within the portion of the wellbore. These values can later be retrieved from the memory for use in the calculations described herein. Such a stored and/or known value of the Earth's rotation rate may herein be referred to as a reference value of the Earth's rotation rate, and such a stored and/or known value of the local latitude may herein be referred to as a reference value of the local latitude.

In addition, as explained above with respect to FIGS. 1-6, the computing system may receive measurements of the Earth's rotation rate about the x-axis, y-axis, and z-axis of the survey tool from one or more quartz CVG sensors of the tool. Measurements of the Earth's rotation rate may also be referred to herein as rotation rate measurements. As noted above, the one or more CVG sensors may include one or more dual-axis CVG sensors, one or more single-axis CVG sensors, or combinations thereof.

In one implementation, the computing system may then determine estimated values of the Earth's rotation rate and the latitude using these rotation rate measurements. The estimated values of the Earth's rotation rate and the local latitude can be computed using the following equations:

$$\begin{matrix}\hat{Ω} = \sqrt{{\hat{ω}}_{x}^{2} + {\hat{ω}}_{y}^{2} + {\hat{ω}}_{z}^{2}} & ( 20 ) \\ \hat{φ} = \frac{( {\hat{ω}}_{x} sin α + {\hat{ω}}_{y} cos α ) sin I - {\hat{ω}}_{z} cos I}{\begin{matrix}( {\hat{ω}}_{x} cos α - {\hat{ω}}_{y} sin α ) sin A + \\ ( ( {\hat{ω}}_{x} sin α + {\hat{ω}}_{y} cos α ) cos I + {\hat{ω}}_{z} sin I ) cos A\end{matrix}} & ( 21 )\end{matrix}$$

where \hat{Ω} represents an estimated value of the Earth's rotation rate and ϕ represents an estimated value of the local latitude. The estimated values may be represented in vector form as:

\hat{z}[\hat{Ω}\hat{ϕ}]^{T} (22).

The measurement differences at a survey station k, which may be represented as:

Δzₖ=\hat{z}ₖ−zₖ=[ΔΩₖΔϕₖ]^{T} (23)

can form the inputs to the Kalman filter process described below. The measurement differences may be expressed in terms of the system error states,

Δxₖ=[ΔBₓΔB_{y}ΔB_{z}]^{T} (24)

via the following linear matrix equation:

Δzₖ=HₖΔxₖ+vₖ (25)

where ΔBₓ represents the measurement bias of the x-axis gyroscopic sensor, ΔB_{y} represents the measurement bias of the y-axis gyroscopic sensor, ΔB_{z} represents the measurement bias of the z-axis gyroscopic sensor, where the elements of Hₖ (e.g., a 2×3 matrix) correspond to the partial derivatives of the Earth's rotation rate and latitude measurement equations at station k, and where vₖ represents the noise in the rotation rate measurements. The covariance of the measurement noise at station k is denoted by the symbol Rₖ.

The uncertainty in state estimates can be expressed in some implementations in terms of a covariance matrix at survey station k, denoted Pₖ. An initial value in certain implementations may be assigned to the diagonal elements of Pₖ, the variances of the error estimates. In certain implementations, initial values may be assigned to gyroscopic measurement bias variances in accordance with the expected variation in these parameter values following office calibration (e.g., calibration before the system is placed within the wellbore). The covariance uncertainty of the predicted state vector is denoted by the symbol Q.

The covariance matrix corresponding to the uncertainty in the predicted state vector in certain embodiments may be represented by:

P_{k/k-1}=P_{k-1/k-1}+Q (26)

where P_{k/k-1} represents the covariance matrix at station k predicted at station k−1 (i.e., the covariance matrix prior to the update using the inclination measurements at station k). In certain implementations, the system states may be corrected following each measurement update, so the best estimate of the state error following each measurement update may be zero. Therefore, the predicted error state may also be zero.

In some implementations, the covariance matrix and the state vector may be updated, following a measurement at station k, using the following equations:

P_{k/k}=P_{k/k-1}−GₖHₖP_{k/k-1} (27)

Δx_{k/k}=Δx_{k/k-1}+GₖΔzₖ (28)

where P_{k/k} represents the covariance matrix following the measurement update at station k, x_{k/k-1} represents the predicted state vector, and x_{k/k} represents the state vector following the measurement update.

The gain matrix Gₖ may be represented by:

Gₖ=P_{k/k-1}Hₖ^{T}[HₖP_{k/k-1}Hₖ^{T}Rₖ]⁻¹ (29).

After each measurement update, the gyroscopic sensor rotation rate measurements (ωₓₖ, ω_{yk}, ω_{zk}) at survey station k may be corrected using the following equations:

\hat{ω}ₓₖ=ωₓₖ−Δx_{k/k} (30)

\hat{ω}_{yk}=ω_{yk}−Δx_{k/k} (31)

\hat{ω}_{zk}=ω_{zk}−Δx_{k/k} (32)

where \hat{ω}ₓₖ represents the bias corrected measurement of the Earth's rotation rate about the x-axis of the survey tool, \hat{ω}_{yk} represents the bias corrected measurement of the Earth's rotation rate about the y-axis of the survey tool, and \hat{ω}_{zk} represents the bias corrected measurement of the Earth's rotation rate about the z-axis of the survey tool.

In a further implementation, the bias corrected measurements of the Earth's rotation rate about the x-axis, the y-axis, and the z-axis of the survey tool may be used to determine an azimuth of the survey tool and, hence, an azimuth of the wellbore. Such implementations may be used to mitigate the impact of bias values on the accuracy of the CVG sensor's measurements and, thus, the azimuth. In one such implementation, Equation 18 may be used to determine the azimuth angle Aₖ of the survey tool at the survey station k using the bias corrected measurements.

In another implementation, the computing system may use the reference values of the Earth's rotation rate and the local latitude to derive reference values for horizontal and/or vertical components of the Earth's rotation rate, such as through the following equations:

Ω_{H}=Ω cos ϕ (33)

Ω_{V}=−Ω sin ϕ (34)

where Ω_{H} represents the horizontal component of the Earth's rotation rate and Ω_{V} represents the vertical component of the Earth's rotation rate. In such an implementation, as similarly discussed above with respect to Equations 23-25, the measurement differences at survey station k between the reference value of the horizontal component of the Earth's rotation rate and the rotation rate measurement about the x-axis of the survey tool at station k can be used to form the inputs to the Kalman filter process. The Kalman filter process may then be followed as described above to determine a bias corrected measurement of the Earth's rotation rate about the x-axis of the survey tool. Further, the measurement differences at survey station k between the reference value of the horizontal component of the Earth's rotation rate and the rotation rate measurement about the y-axis of the survey tool at station k can be used to form the inputs to the Kalman filter process, and which ultimately may be used to determine a bias corrected measurement of the Earth's rotation rate about the y-axis of the survey tool. In another such implementation, as similarly discussed above with respect to Equations 23-25, the measurement differences at survey station k between the reference value of the vertical component of the Earth's rotation rate and the rotation rate measurement about the z-axis of the survey tool at station k can be used to form the inputs to the Kalman filter process. The Kalman filter process may then be followed as described above to determine a bias corrected measurement of the Earth's rotation rate about the z-axis of the survey tool. The bias corrected measurements of the Earth's rotation rate about the x-axis, the y-axis, and the z-axis of the survey tool may be used to determine an azimuth of the survey tool and, hence, an azimuth of the wellbore.

### Least-Squares Adjustment Process

In one implementation, the statistical estimation process used to estimate a residual measurement bias associated with each CVG sensor of a survey tool may be in the form of a least-squares adjustment process. The least-squares adjustment process may be applied to rotation rate measurements acquired using any survey tool known in the art, including survey tools configured to perform post-drilling applications (e.g., wireline surveys, slickline surveys, or drop surveys). In particular, measurements of Earth's rate and/or local latitude may be used for a sequence of survey stations and processed to derive the bias estimates.

In some implementations, a computing system may estimate measurement biases using the least squares adjustment process based on reference values of the Earth's rotation rate and the local latitude of the survey tool, as similarly described above. In addition, as explained above with respect to FIGS. 1-6, the computing system may receive rotation rate measurements about the x-axis, y-axis, and z-axis of the survey tool from one or more quartz CVG sensors of the tool. As noted above, the one or more CVG sensors may include one or more dual-axis CVG sensors, one or more single-axis CVG sensors, or combinations thereof.

The computing system may then determine estimated values of the Earth's rotation rate and the latitude using these rotation rate measurements, such as through Equations 20 and 21. The estimated values may be represented in vector form as shown in Equation 22. The error terms may again be expressed in terms of a 3-state error estimation vector Δx, where:

Δxₖ=[ΔBₓΔB_{y}ΔB_{z}]^{T} (35)

and measurement differences, between the reference values and estimated values of the Earth's rotation rate and local latitude, at each survey station k, may be represented as:

Δzₖ=\hat{z}ₖ−zₖ=[ΔΩₖΔϕₖ]^{T} (36).

The measurement differences may form inputs to the least-squares adjustment process and may be based on a measurement error model, where the model may be expressed in terms of the following matrix equation:

Δzₖ=HₖΔxₖ (37)

where the measurement matrix H relates the measurement differences to the error states and may be formed from the partial derivatives of the measurement equation.

Rotation rate measurements may be collected at each survey station over a section of the well path to form the complete measurement vector for m survey stations:

ΔZ=[Δz₁Δz₂ . . . Δzₘ]^{T} (38).

The least-squares estimates of the error states may be generated using:

Δx=[ [symbol] ^{T} [symbol] ]⁻¹ [symbol] ΔZ (39)

where [symbol] represents a 2m×3 matrix comprising the H matrices for each survey station, H₁ to Hₘ:

[symbol]

=[H₁H₂ . . . Hₘ]^{T} (40).

An iterative estimation process based on the least-squares adjustment process may be conducted by performing the estimation calculation for a fixed number of readings (e.g., collected over 5 to 10 stations) before advancing to the next station and repeating the process using the same number of readings. The new station may be added while removing the initial station from the first set of readings. As a result, the first set of readings may be used to initiate the process, and the estimation calculation may be repeated at each station thereafter.

As such, for each survey station, the computing system may determine bias corrected measurements of Earth's rotation rate about the x-axis, y-axis, and z-axis of the survey tool by removing the determined error from the rotation rate measurements at the station, as similarly shown above with Equations 30-32. The bias corrected measurements of the Earth's rotation rate about the x-axis, the y-axis, and the z-axis of the survey tool may be used to determine an azimuth of the survey tool and, hence, an azimuth of the wellbore. In another implementation, the least-squares adjustment process may be applied during the drilling process, such as for a post-drilling update of a drop or wireline survey by using the complete set of measurements taken for the section of well under consideration. The full survey may then be recalculated with the bias corrections applied.

Though the Kalman filter process and the least-squares adjustment process are described above, those skilled in the art will understand that one or more other types of statistical estimation processes known in the art may be used to estimate a residual measurement bias associated with each CVG sensor of a survey tool. In some implementations, estimates of one or more additional gyroscopic sensor errors may be included as part of the estimation process described herein. Examples of the additional gyroscopic sensor errors which can be calculated in accordance with certain implementations described herein include, but are not limited to, scale factor errors, mounting misalignments, and/or gravity dependent errors.

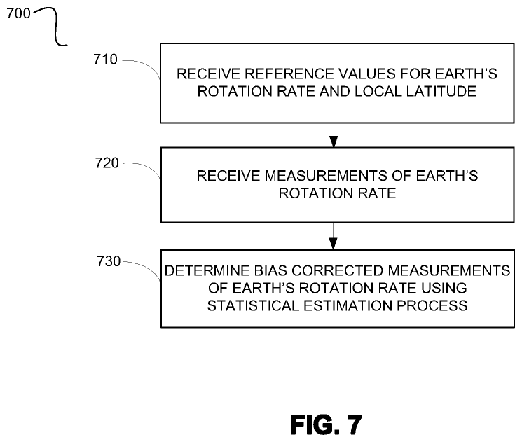

FIG. 7 illustrates a flow diagram of a method 700 for correction of rotation rate measurements in accordance with implementations of various techniques described herein. In one implementation, method 700 may be at least partially performed by a computing system, such as the computing system 130 discussed above. It should be understood that while method 700 indicates a particular order of execution of operations, in some implementations, certain portions of the operations might be executed in a different order. Further, in some implementations, additional operations or steps may be added to the method 700. Likewise, some operations or steps may be omitted. As noted above, the computing system may be configured to receive measurements of the Earth's rotation rate from the one or more CVG sensors of the tool, and to calculate information regarding one or more bias values in the measurements.

At block 710, the computing system may receive one or more reference values for the Earth's rotation rate and a local latitude of a survey tool. As noted above, the reference values may represent known quantities, as their values may be obtained from sources that are separate and/or independent from the survey tool. Further, the Earth's rate and the local latitude can be used as pseudo-measurements in a statistical estimation process and may be expressed in vector form.

At block 720, the computing system may receive one or more measurements of the Earth's rotation rate about the x-axis, y-axis, and z-axis of the survey tool from one or more quartz CVG sensors of the survey tool. As noted above, the one or more CVG sensors may include a dual-axis CVG sensor, one or more single-axis CVG sensors, or combinations thereof.

At block 730, the computing system may determine a bias corrected measurement of the Earth's rotation rate about the x-axis of the survey tool, may determine a bias corrected measurement of the Earth's rotation rate about the y-axis of the survey tool, and may determine a bias corrected measurement of the Earth's rotation rate about the z-axis of the survey tool using one or more statistical estimation processes. As noted above, the one or more statistical estimation processes may include a Kalman filter process, a least-squares adjustment process, and/or the like. In one implementation, the Kalman filter process may allow for the estimates of measurement bias to be updated at each survey station, as described above. The received rotation rate measurements at each survey station may then be corrected by removing the corresponding bias values. In another implementation, the least-squares adjustment process may be used for a sequence of survey stations and processed to derive the bias estimates at each survey station. Similarly, the received rotation rate measurements at each survey station may then be corrected by removing the corresponding bias values.

In a further implementation, the bias corrected measurements of the Earth's rotation rate about the x-axis, the y-axis, and the z-axis of the survey tool may be used to determine an azimuth of the survey tool and, hence, an azimuth of the wellbore. In turn, for some implementations, the survey tool may perform drilling operations based on this determined azimuth, such as to maintain or change a trajectory of the tool.

Implementations relating to a wellbore survey tool using CVG sensors are disclosed herein. In particular, the survey tool may include quartz CVG sensors to perform a directional survey to measure an inclination and azimuth at selected positions along a wellbore. However, as noted above, the measurements provided by a CVG sensor of a survey tool may contain fixed, systematic errors or biases that may severely impact the accuracy of the sensor's measurements and, thus, the azimuth.

As such, the implementations described herein may be used to remove or reduce these measurement biases in the measurements from a CVG sensor using one or more statistical estimation processes. By using a statistical estimation process to remove measurement biases, an instrument configuration of the survey tool may be simplified mechanically, as one or more of its indexing mechanisms (e.g., motor unit 245 of FIG. 2) may not be needed. Further, the CVG sensors may be fixed rigidly within the survey tool in what may be referred to as a strapdown configuration. The removal of the indexing mechanisms may result in a simpler and more robust mechanical design for the tool, which may lead to cost savings. In particular, cost savings in the design and construction of the survey tool may make the implementations described herein to be a cost-effective option for post-drilling survey applications in which drop survey tools or wireline survey tools are used. Further, the removal of the indexing mechanisms may also allow for some reduction in the physical size of the survey tool. This reduction in size may allow for gyroscopic survey methods to be used in a wider range of drilling tools, such as in rotary steerable tools where the space in which sensors can be accommodated may be limited.

### Computing System

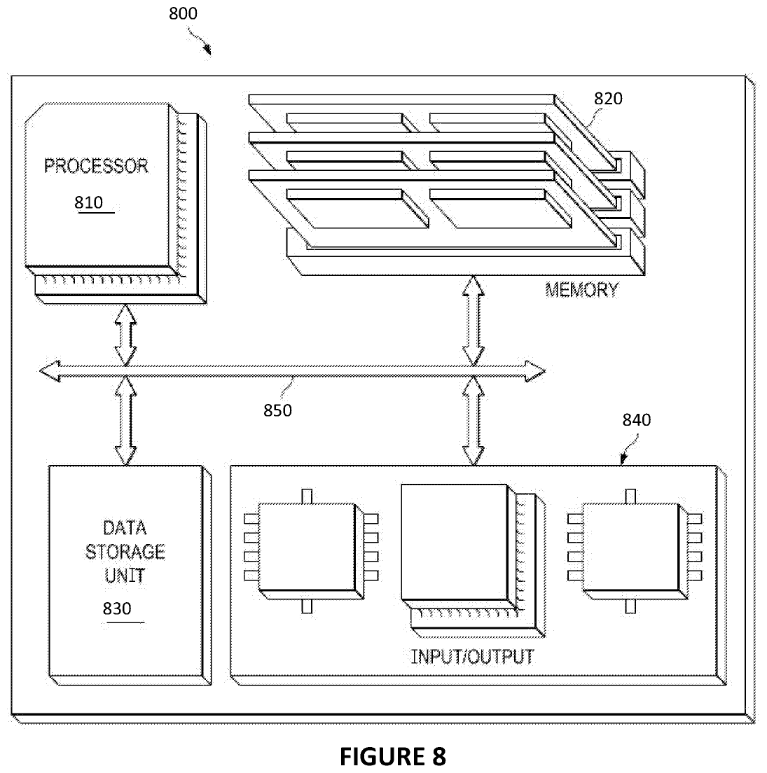

FIG. 8 illustrates a block diagram of a hardware configuration 800 in which one or more various technologies described herein may be incorporated and practiced. The hardware configuration 800 can be used to implement the computing systems discussed above (e.g., the computing system 130). The hardware configuration 800 can include a processor 810, a memory 820, a storage device 830, and an input/output device 840. Each of the components 810, 820, 830, and 840 can, for example, be interconnected using a system bus 850. The processor 810 can be capable of processing instructions for execution within the hardware configuration 800. In one implementation, the processor 810 can be a single-threaded processor. In another implementation, the processor 810 can be a multi-threaded processor. The processor 810 can be capable of processing instructions stored in the memory 820 or on the storage device 830.

The memory 820 can store information within the hardware configuration 800. In one implementation, the memory 820 can be a computer-readable medium. In one implementation, the memory 820 can be a volatile memory unit. In another implementation, the memory 820 can be a non-volatile memory unit.

In some implementations, the storage device 830 can be capable of providing mass storage for the hardware configuration 800. In one implementation, the storage device 830 can be a computer-readable medium. In various different implementations, the storage device 830 can, for example, include a hard disk device/drive, an optical disk device, flash memory or some other large capacity storage device. In other implementations, the storage device 830 can be a device external to the hardware configuration 800. Various implementations for the memory 820 and/or the storage device 830 are further discussed below.

The input/output device 840 can provide input/output operations for the hardware configuration 800. In one implementation, the input/output device 840 can include one or more display system interfaces, sensors and/or data transfer ports.

The subject matter of this disclosure, and/or components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output thereby tying the process to a particular machine, e.g., a machine programmed to perform the processes described herein. The processes and logic flows can also be performed by, and apparatus can also be implemented as, special purpose logic circuitry, e.g., an FPGA (field programmable gate array) or an ASIC (application specific integrated circuit).

Computer readable media (e.g., memory 820 and/or the storage device 830) suitable for storing computer program instructions and data may include all forms of non-volatile memory, media, and memory devices, including, by way of example, any semiconductor memory devices (e.g., EPROM, EEPROM, solid state memory devices, and flash memory devices); any magnetic disks (e.g., internal hard disks or removable disks); any magneto optical disks; and any CD-ROM and DVD-ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method, comprising:
receiving one or more reference values corresponding to the Earth's rotation rate and one or more reference values corresponding to a local latitude of a survey tool disposed in a wellbore;
receiving a plurality of rotation rate measurements from one or more quartz Coriolis vibratory gyroscopic (CVG) sensors of the survey tool;
determining a plurality of bias-corrected rotation rate measurements using one or more statistical estimation processes and based on the one or more reference values corresponding to the Earth's rotation rate, the one or more reference values corresponding to the local latitude, and the plurality of rotation rate measurements; and
determining a plurality of azimuth values of the survey tool based on the plurality of bias-corrected rotation rate measurements.

2. The method of claim 1, wherein receiving the plurality of rotation rate measurements comprises receiving the plurality of rotation rate measurements about an x-axis, a y-axis, and a z-axis of the survey tool, wherein the z-axis corresponds to a longitudinal axis of the survey tool, and wherein the x-axis and y-axis are substantially perpendicular to the z-axis.

3. The method of claim 1, wherein receiving the plurality of rotation rate measurements comprises:
receiving one or more first rotation rate measurements about a first axis of the survey tool from a first quartz CVG sensor of the survey tool;
receiving one or more second rotation rate measurements about a second axis of the survey tool from a second quartz CVG sensor of the survey tool; and
receiving one or more third rotation rate measurements about a third axis of the survey tool from a third quartz CVG sensor of the survey tool.

4. The method of claim 1, wherein receiving the one or more reference values corresponding to the Earth's rotation rate and the one or more reference values corresponding to the local latitude comprises receiving the one or more reference values corresponding to the Earth's rotation rate and the one or more reference values corresponding to the local latitude from a storage device.

5. The method of claim 1, further comprising:
drilling the wellbore based on the determined plurality of azimuth values;
generating a post-drilling survey of the wellbore based on the determined plurality of azimuth values; or
combinations thereof.

6. The method of claim 1, wherein the one or more statistical estimation processes comprises a Kalman filter process, and wherein determining a plurality of bias-corrected rotation rate measurements comprises:
determining one or more estimated values corresponding to the Earth's rotation rate and one or more estimated values corresponding to the local latitude of the survey tool based on the plurality of rotation rate measurements;
determining one or more first differences between the one or more reference values corresponding to the Earth's rotation rate and the one or more estimated values corresponding to the Earth's rotation rate;
determining one or more second differences between the one or more reference values corresponding to the local latitude and the one or more estimated values corresponding to the local latitude;
using the one or more first differences and the one or more second differences as inputs to the Kalman filter process;
determining a plurality of bias values for the plurality of rotation rate measurements based on the Kalman filter process; and
determining a plurality of bias-corrected rotation rate measurements based on the Kalman filter process, comprising removing the plurality of bias values from the plurality of rotation rate measurements.

7. The method of claim 1, wherein the one or more statistical estimation processes comprises a Kalman filter process, and wherein determining a plurality of bias-corrected rotation rate measurements comprises:
determining a reference value for a horizontal component of the Earth's rotation rate, a reference value for a vertical component of the Earth's rotation rate, or combinations thereof;
determining one or more differences between the plurality of rotation rate measurements and the reference value for the horizontal component of the Earth's rotation rate, the reference value for the vertical component of the Earth's rotation rate, or combinations thereof;
using the one or more differences as inputs to the Kalman filter process;
determining a plurality of bias values for the plurality of rotation rate measurements based on the Kalman filter process; and
determining a plurality of bias-corrected rotation rate measurements based on the Kalman filter process, comprising removing the plurality of bias values from the plurality of rotation rate measurements.

8. The method of claim 1, wherein the one or more statistical estimation processes comprises a least-squares adjustment process, and wherein determining a plurality of bias-corrected rotation rate measurements comprises:
determining one or more estimated values corresponding to the Earth's rotation rate and one or more estimated values corresponding to the local latitude of the survey tool based on the plurality of rotation rate measurements;
determining one or more first differences between the one or more reference values corresponding to the Earth's rotation rate and the one or more estimated values corresponding to the Earth's rotation rate;
determining one or more second differences between the one or more reference values corresponding to the local latitude and the one or more estimated values corresponding to the local latitude;
using the one or more first differences and the one or more second differences as inputs to the least-squares adjustment process;
determining a plurality of bias values for the plurality of rotation rate measurements based on the least-squares adjustment process; and
determining a plurality of bias-corrected rotation rate measurements based on the least-squares adjustment process, comprising removing the plurality of bias values from the plurality of rotation rate measurements.

9. The method of claim 1, wherein the survey tool comprises a measurement-while-drilling (MWD) survey tool or a gyro-while-drilling (GWD) survey tool.

10. The method of claim 1, wherein determining the plurality of bias-corrected rotation rate measurements comprises:
determining a first bias corrected rotation rate measurement about a first axis of the survey tool based a first quartz CVG sensor of the survey tool;
determining a second bias corrected rotation rate measurement about a second axis of the survey tool based on a second quartz CVG sensor of the survey tool; and
determining a third bias corrected rotation rate measurement about a third axis of a survey tool based on a third quartz CVG sensor of the survey tool.

11. A system, comprising:
a survey tool disposed in a wellbore, comprising one or more quartz Coriolis vibratory gyroscopic (CVG) sensors;
a processor; and
a memory comprising a plurality of program instructions which, when executed by the processor, cause the processor to:
receive one or more reference values corresponding to the Earth's rotation rate and one or more reference values corresponding to a local latitude of a survey tool disposed in a wellbore;
receive a plurality of rotation rate measurements from the one or more quartz CVG sensors of the survey tool;
determine a plurality of bias-corrected rotation rate measurements using one or more statistical estimation processes and based on the one or more reference values corresponding to the Earth's rotation rate, the one or more reference values corresponding to the local latitude, and the plurality of rotation rate measurements; and
determine a plurality of azimuth values of the survey tool based on the plurality of bias-corrected rotation rate measurements.

12. The system of claim 11, wherein the one or more statistical estimation processes comprises a Kalman filter process, a least-squares adjustment process, or combinations thereof.

13. The system of claim 11, wherein the one or more statistical estimation processes comprises a Kalman filter process, and wherein the plurality of program instructions which, when executed by the processor, cause the processor to determine a plurality of bias-corrected rotation rate measurements further comprises program instructions which, when executed by the processor, cause the processor to:
determine one or more estimated values corresponding to the Earth's rotation rate and one or more estimated values corresponding to the local latitude of the survey tool based on the plurality of rotation rate measurements;
determine one or more first differences between the one or more reference values corresponding to the Earth's rotation rate and the one or more estimated values corresponding to the Earth's rotation rate;
determine one or more second differences between the one or more reference values corresponding to the local latitude and the one or more estimated values corresponding to the local latitude;
use the one or more first differences and the one or more second differences as inputs to the Kalman filter process;
determine a plurality of bias values for the plurality of rotation rate measurements based on the Kalman filter process; and
determine a plurality of bias-corrected rotation rate measurements based on the Kalman filter process, comprising removing the plurality of bias values from the plurality of rotation rate measurements.

14. The system of claim 11, wherein the one or more statistical estimation processes comprises a Kalman filter process, and wherein the plurality of program instructions which, when executed by the processor, cause the processor to determine a plurality of bias-corrected rotation rate measurements further comprises program instructions which, when executed by the processor, cause the processor to:
determine a reference value for a horizontal component of the Earth's rotation rate, a reference value for a vertical component of the Earth's rotation rate, or combinations thereof;
determine one or more differences between the plurality of rotation rate measurements and the reference value for the horizontal component of the Earth's rotation rate, the reference value for the vertical component of the Earth's rotation rate, or combinations thereof;
use the one or more differences as inputs to the Kalman filter process;
determine a plurality of bias values for the plurality of rotation rate measurements based on the Kalman filter process; and
determine a plurality of bias-corrected rotation rate measurements based on the Kalman filter process, comprising removing the plurality of bias values from the plurality of rotation rate measurements.

15. The system of claim 11, wherein the one or more statistical estimation processes comprises a least-squares adjustment process, and wherein the plurality of program instructions which, when executed by the processor, cause the processor to determine a plurality of bias-corrected rotation rate measurements further comprises program instructions which, when executed by the processor, cause the processor to:
determine one or more estimated values corresponding to the Earth's rotation rate and one or more estimated values corresponding to the local latitude of the survey tool based on the plurality of rotation rate measurements;
determine one or more first differences between the one or more reference values corresponding to the Earth's rotation rate and the one or more estimated values corresponding to the Earth's rotation rate;
determine one or more second differences between the one or more reference values corresponding to the local latitude and the one or more estimated values corresponding to the local latitude;
use the one or more first differences and the one or more second differences as inputs to the least-squares adjustment process;
determine a plurality of bias values for the plurality of rotation rate measurements based on the least-squares adjustment process; and
determine a plurality of bias-corrected rotation rate measurements based on the least-squares adjustment process, comprising removing the plurality of bias values from the plurality of rotation rate measurements.

16. A method, comprising:
receiving one or more reference values corresponding to the Earth's rotation rate and one or more reference values corresponding to a local latitude of a survey tool disposed in a wellbore;
receiving a plurality of rotation rate measurements from one or more quartz Coriolis vibratory gyroscopic (CVG) sensors about an x-axis, a y-axis, and a z-axis of the survey tool, wherein the z-axis corresponds to a longitudinal axis of the survey tool, and wherein the x-axis and y-axis are substantially perpendicular to the z-axis;
determining a plurality of bias-corrected rotation rate measurements using one or more statistical estimation processes and based on the one or more reference values corresponding to the Earth's rotation rate, the one or more reference values corresponding to the local latitude, and the plurality of rotation rate measurements;
determining a plurality of azimuth values of the survey tool based on the plurality of bias-corrected rotation rate measurements;
generating a survey of the wellbore based on the plurality of azimuth values; and
drilling the wellbore based on the generated survey.

17. The method of claim 16, wherein receiving the one or more reference values corresponding to the Earth's rotation rate and the one or more reference values corresponding to the local latitude comprises receiving the one or more reference values corresponding to the Earth's rotation rate and the one or more reference values corresponding to the local latitude from a storage device.

18. The method of claim 16, wherein the one or more statistical estimation processes comprises a Kalman filter process, and wherein determining a plurality of bias-corrected rotation rate measurements comprises:
determining one or more estimated values corresponding to the Earth's rotation rate and one or more estimated values corresponding to the local latitude of the survey tool based on the plurality of rotation rate measurements;
determining one or more first differences between the one or more reference values corresponding to the Earth's rotation rate and the one or more estimated values corresponding to the Earth's rotation rate;
determining one or more second differences between the one or more reference values corresponding to the local latitude and the one or more estimated values corresponding to the local latitude;
using the one or more first differences and the one or more second differences as inputs to the Kalman filter process;
determining a plurality of bias values for the plurality of rotation rate measurements based on the Kalman filter process; and
determining a plurality of bias-corrected rotation rate measurements based on the Kalman filter process, comprising removing the plurality of bias values from the plurality of rotation rate measurements.

19. The method of claim 16, wherein the one or more statistical estimation processes comprises a Kalman filter process, and wherein determining a plurality of bias-corrected rotation rate measurements comprises:
determining a reference value for a horizontal component of the Earth's rotation rate, a reference value for a vertical component of the Earth's rotation rate, or combinations thereof;
determining one or more differences between the plurality of rotation rate measurements and the reference value for the horizontal component of the Earth's rotation rate, the reference value for the vertical component of the Earth's rotation rate, or combinations thereof;
using the one or more differences as inputs to the Kalman filter process;
determining a plurality of bias values for the plurality of rotation rate measurements based on the Kalman filter process; and
determining a plurality of bias-corrected rotation rate measurements based on the Kalman filter process, comprising removing the plurality of bias values from the plurality of rotation rate measurements.

20. The method of claim 16, wherein the one or more statistical estimation processes comprises a least-squares adjustment process, and wherein determining a plurality of bias-corrected rotation rate measurements comprises:
determining one or more estimated values corresponding to the Earth's rotation rate and one or more estimated values corresponding to the local latitude of the survey tool based on the plurality of rotation rate measurements;
determining one or more first differences between the one or more reference values corresponding to the Earth's rotation rate and the one or more estimated values corresponding to the Earth's rotation rate;
determining one or more second differences between the one or more reference values corresponding to the local latitude and the one or more estimated values corresponding to the local latitude;
using the one or more first differences and the one or more second differences as inputs to the least-squares adjustment process;
determining a plurality of bias values for the plurality of rotation rate measurements based on the least-squares adjustment process; and
determining a plurality of bias-corrected rotation rate measurements based on the least-squares adjustment process, comprising removing the plurality of bias values from the plurality of rotation rate measurements.
